(19) United States
(12) Patent Application Publication
(10) Pub. No.: US 2005/0050394 A1
(43) Pub. Date: Mar. 3, 2005

(54) System that uses reference codes to establish properties of grogram modules and method of the same

(76) Inventor: Chih-Hung Chien, Taoyuan Hsien (TW)

Correspondence Address: HARNESS, DICKEY & PIERCE, P.L.C., P.O. BOX 8910, RESTON, VA, 20195, US

(21) Appl. No.: 10/648,404

(22) Filed: Aug. 27, 2003

(51) Int. Cl. G06F 11/00

(52) U.S. Cl. 714/38

(57) ABSTRACT

A system and a method that use reference codes to establish properties of program modules. It includes a storage medium for storing a table with function descriptions and the corresponding reference codes, describing the function properties of each program module. Each of the program modules has a program pointer with a specific reference code. When writing a program, one follows the function description and reference code table to insert the reference codes into the source codes of different program properties. They are then used as the reference for programming, linking and debugging.

### BACKGROUND OF THE INVENTION

1. Field of Invention

The invention relates to a system and method for compiling source codes and, in particular, to a system and a method that uses reference codes to establish properties of program modules.

2. Related Art

FIG. 1 is a flowchart of how a program is compiled and linked conventionally. Normal programming is done in the following way. First, a software engineer composes a source code for the required functions (step 110). Secondly, the source code is compiled (step 120). An objective code is thus generated (step 130) and linked (step 140). Finally, an executable program is completed (step 150).

Since there are more functions in software, the accumulated source codes become more complicated. This does not only make programming harder than before, the debugging efficiency is also greatly reduced. It is therefore very difficult to add, update, or delete certain functions to existing programs.

On the other hand, the popularity of Internet has created immense amount of business opportunities. The application programs for web page interfaces are being updated all the time in order to catch up with the practical needs. Thus, unlike utilities on a stand-alone machine that are updated less frequently, web page interface programs may have to be updated at any moment.

Moreover, a complete software program may be accomplished with the efforts of many different engineers. In other words, the software may be an integration of a lot of little programs written by different people in order to achieve many powerful functions.

In order to make the program more readable so that different program modules can be readily linked and to increase the debugging efficiency, it is imperative to provide a reference method that allows independent programming and has specific meanings.

### SUMMARY OF THE INVENTION

The invention discloses a system and method that use reference codes to establish properties of program modules. The system contains a storage medium for recording a table with function descriptions and corresponding reference codes to describe the function properties of all program modules. Each program module has a program pointer with a specific reference code. The reference codes are inserted into the source codes of different program modules for the reference of programming, linking, and debugging.

An objective of the invention is to provide a reference for software engineers to compose programs. The debugging efficiency can be greatly enhanced. When a software program needs to be updated or modified, the invention can effectively add or delete certain functional modules.

The reference codes of the invention can be assigned with different levels for future expansion of the references.

### BRIEF DESCRIPTION OF THE DRAWINGS

The invention will become more fully understood from the detailed description given hereinbelow illustration only, and thus are not limitative of the present invention, and wherein:

FIG. 1 is a flowchart of the conventional way of compiling and linking software programs;

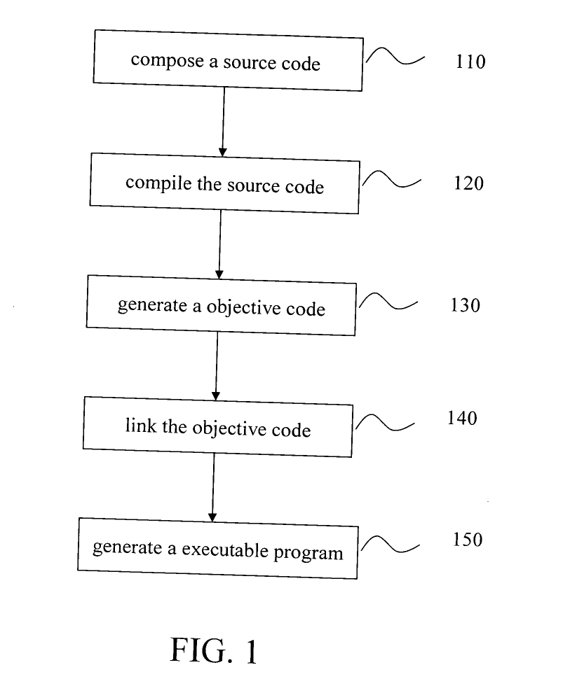

FIG. 2 is a block diagram of the disclosed address reference codes system to establish properties of program modules;

FIG. 3A is a flowchart of compiling and linking using the reference codes to establish properties of program modules; and

FIG. 3B is a flowchart of compiling and linking according to a preferred embodiment of the invention.

### DETAILED DESCRIPTION OF THE INVENTION

The invention provides a system and method that use reference codes to establish properties of program modules. During the software programming period, the functions of each program are organized according to their logic order and manpower. Once a function is completed, it is immediately checked in order to lower the error rate. Even though there might be some minor corrections later on, they will not change the whole system structure. With the program module properties, one can follow the reference codes to readily identify each functional program to perform debugging or functional modifications.

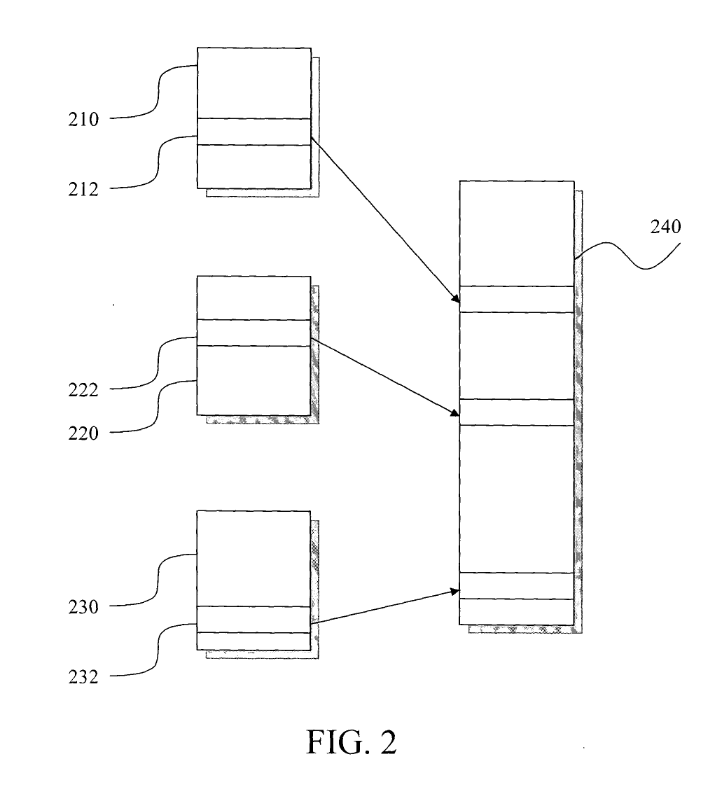

With reference to FIG. 2, each of the single-function program 210, 220, 230 is inserted with predetermined reference codes 212, 222, 232, respectively. They form an integrated program 240 after linking. It should be mentioned that the reference codes 212, 222, 232 are program pointers with specific functions, not the command macros in normal libraries or the program pointers of resident subroutines. The reference codes 212, 222, 232 are ordered and arranged using numbers (such as 1000, 2000, 3000, etc.) and placed inside the source codes. They are inserted without affecting program compiling and linking and are used for the reference of programming, linking, and debugging. Therefore, even a huge program can be easily updated or modified at any time.

Taking manufacturing supply chain software as an example, the program pointers of specific functions may contain program modules with different properties. Such functions include item, purchasing order, production order, actual ship, open sales order, on-hand stock, bill of material (BOM), material related data, vendor source list, and quotation of prices. To integrate and link the above-mentioned different programs may require different “domain know how.” Therefore, they have to be written by software engineers with different professions.

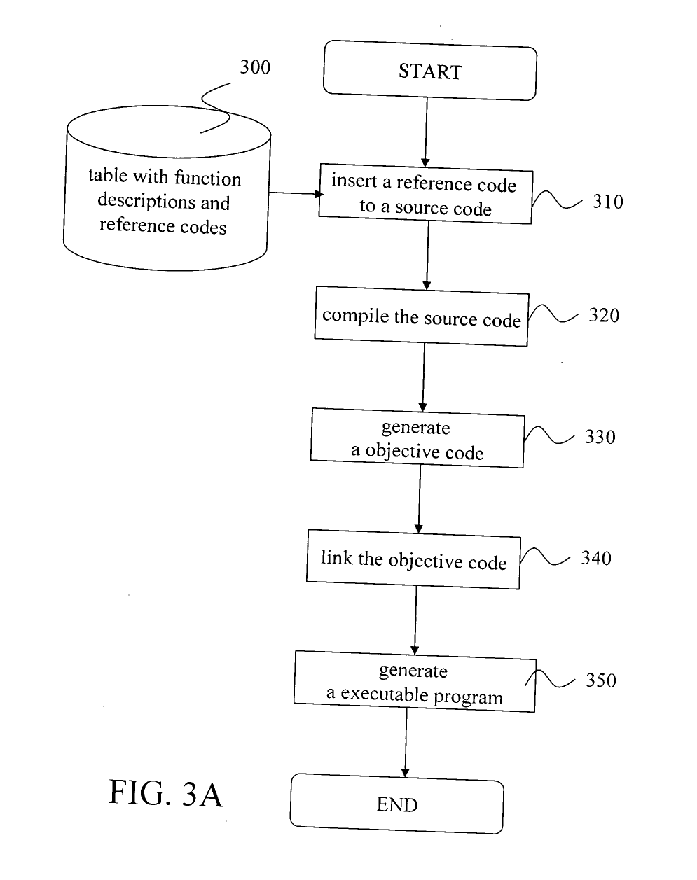

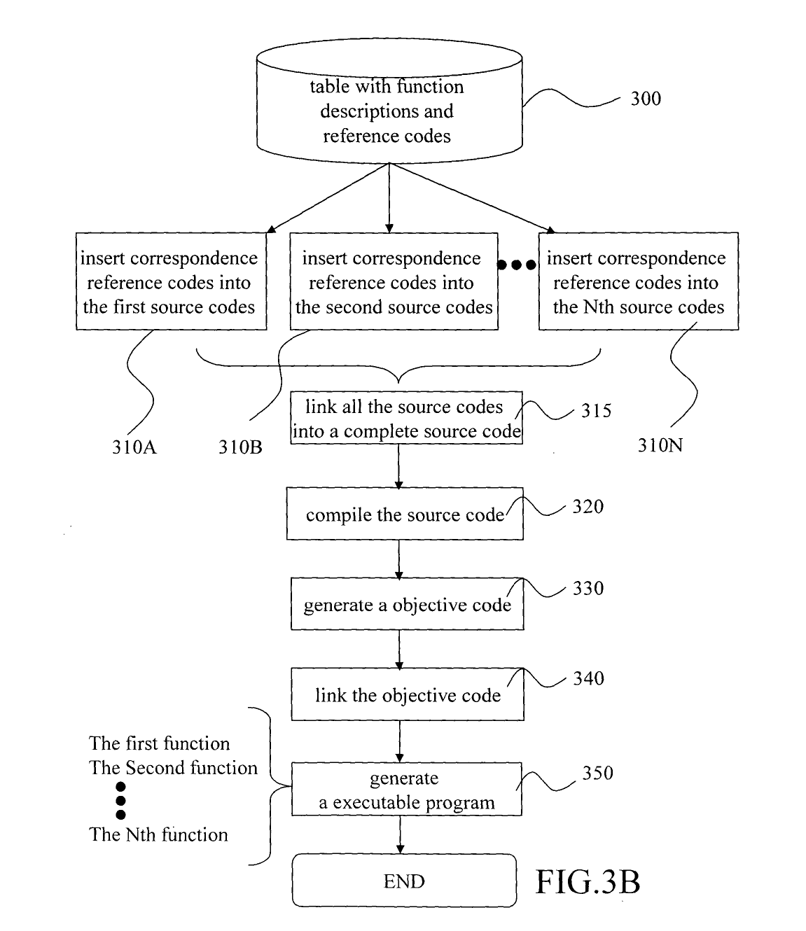

As shown in FIG. 3A, the invention first establishes a table 300 with function descriptions and reference codes in a storage medium. It provides software engineers the reference for programming and setting module properties. It is mainly used to define program module with different functional properties. Since the expanded functions and application range may be very large, one needs to assign different levels when defining the table 300 so that future expanded program modules can be fitted in. Once the table 300 is completed, each functional program is inserted with a reference code in the source code (step 310). Afterwards, the source codes are compiled (step 320) to generate objective codes (step 330), which are then linked (step 340) to produce a final, executable program (step 350). The executable program contains hidden properties references, which provide software engineer detailed program pointer information without affecting the program execution efficiency at all.

Please refer to FIG. 3B. As described before, we use the function description and reference code correspondence table 300 to insert reference codes into the first to the Nth source codes (steps 310A˜310N). All the source codes are linked into a complete program (step 315). Since each subroutine program has a distinct reference code, the property assignment and combination is unique and independent of one another. Afterwards, the programs are compiled (step 320) to generate objective codes (step 330), which are then linked (step 340) to produce a final, executable program (step 350). The executable program has complete functions of different properties.

Certain variations would be apparent to those skilled in the art, which variations are considered within the spirit and scope of the claimed invention.

1. A system that uses reference codes to establish properties of program modules, wherein the improvement comprises: a storage medium for recording a function description and reference code correspondence table to describe the properties of the program modules; and each of the program modules has a program pointer point towards a specific reference code and the reference codes are inserted into the source codes of different properties of program modules during programming so that serve as a reference for programming, linking and debugging.

2. The system of claim 1, wherein the reference codes are assigned and arranged using numbers.

3. The system of claim 1, wherein the program modules are selected from the group consisting of item, purchasing order, production order, actual ship, open sales order, on-hand stock, bill of material (BOM), material related data, vendor source list, and quotation of prices as used in manufacturing supply chains.

4. A method that uses reference codes to establish properties of program modules so that serve as a reference for programming, linking, and debugging for an immense program source code to be easily updated and modified, comprising the steps of:
establishing a function description and reference code correspondence table and recording the table in a storage medium;
inserting the reference codes into corresponding source codes;
linking each of the source codes to generate a complete source code; and
compiling and linking the complete source code to produce an executable program.

5. The method of claim 4, wherein the reference codes are assigned and arranged using numbers.

6. The method of claim 4, wherein the program modules are selected from the group consisting of item, purchasing order, production order, actual ship, open sales order, on-hand stock, bill of material (BOM), material related data, vendor source list, and quotation of prices as used in manufacturing supply chains.
